(19) United States
(12) Patent Application Publication
(10) Pub. No.: US 2002/0001743 A1
(43) Pub. Date: Jan. 3, 2002

(54) Composite bipolar plate separator structrues for polymer electrolyte membrane (PEM) electrochemical and fuel cells

(76) Inventor: John Herbert Davis, Beaconsfield (CA)

Correspondence Address: RIDOUT & MAYBEE LLP, Suite 2400, One Queen St. East, Toronto, ON, M5C 3B1, CA

(21) Appl. No.: 09/778,002

(22) Filed: Feb. 7, 2001

(30) Foreign Application Priority Data
Feb. 8, 2000 (GB) 0002865.4

(51) Int. Cl. H01M 8/02

(52) U.S. Cl. 429/34

(57) ABSTRACT

A bipolar separator plate for electrochemical cells, comprising a core layer (2) of a metal having high electrical and thermal conductivity and having oppositely facing surfaces and cladding layers (4) mechanically bonded to each of the oppositely facing surfaces. Each cladding layer (4) comprises an electrically-conductive polymer resistant to the electrochemical and environmental conditions to which will be exposed in the cell and effective to protect the core layer (2) from such conditions. The cladding layers (4) allow the separator plate to be used for extended periods of time in electrochemical cells and, in particular, in fuel cells of the PEM type.

### BACKGROUND AND PRIOR ART

Bipolar separator plates for polymer electrolyte membrane (PEM) fuel cells in a fuel cell stack and other electrochemical cell batteries are one of the most critical components of the fuel cell stack and can have a major impact not only on the performance of the stack but also on its cost.

Many of the PEM fuel cells that have been demonstrated to date have used bipolar plates machined from dense graphite plates. These cells have demonstrated attractive performance, but at the expense of cost. The graphite material used for the bipolar plates is brittle and difficult to work with and is intrinsically costly to form into the required shapes. These shortcomings not only apply to fuel cells but also to other types of electrochemical cell batteries that are used to produce such chemicals as chlorine/caustic soda and hydrogen. These electrochemical cells also require chemically inert, robust and low cost bipolar separators. As a result of these needs there have been numerous efforts made to replace graphite separator plates with less costly, conductive material that can easily be moulded or formed into the required bipolar plate structures. A patent issued to United Technologies Corp., U.S. Pat. No. 4,301,222 entitled “Separator plate for electrochemical cells”, describes how a thin electrochemical cell separator plate with greatly improved properties is made by moulding and then graphitizing a mixture of preferably 50 per cent high purity graphite powder and 50 per cent of a carbonisable thermosetting phenolic resin. The appropriate choice of graphite powder and of carbonizing conditions allowed a 0.150 inch (3.8 mm) thick bipolar plate to be made that showed an initial flexural strength of 4000 psi and a through the plate electrical resistivity of 0.011 ohm-cm (this is about ten times higher than pure graphite, which has a resistivity of approximately 0.00138 ohm-cm). This type of plate could potentially be used in PEM fuel cells, but the samples were reported to be about 5% porous and would therefore need to be further densified or impregnated in order to be suitable for use in PEM type fuel cells. This patent divulges a manner of fabricating a bipolar plate, which is chemically equivalent to carbon after the fabrication process is complete. It offers some advantage in terms of being able to use an initial moulding process, but the complete fabrication procedure is still quite complicated.

U.S. Pat. No. 4,197,178, issued to Oronzio deNora Impianti Electtrochimici S.p.A. and entitled “Bipolar separator for electrochemical calls and method of preparation thereof”, is similar. In this case, however, the thermosetting resin is not carbonized. Using the procedures defined in this patent, resistivities in the direction perpendicular to the major surfaces of moulded separator of less than 0.3 ohm-cm are reported to be obtained (this resistivity is some 300 times higher than that reported for pure graphite or 30 times higher than when the resin is carbonized as in the above referenced patent). The problem of the sensitivity of the thermosetting resin to oxidative attack in the anode chamber is addressed by having the entire surface exposed to the anolyte, except in the area of electrical contact with the anode, coated with a layer of chemically resistant and electrically non-conductive resin.

It has been proposed to blend the conductive graphite powder with a chemically resistant moulding resin so as to avoid the complications divulged in the deNora patent. U.S. Pat. No. 4,214,969, issued to the GE company and entitled “Low cost bipolar current collector-separator for electrochemical cells” covers the use of a moulded aggregate of electroconductive graphite and a thermoplastic fluoropolymer. Bulk resistivities of less than 0.010 ohm-cm are claimed together with excellent corrosion resistance to a variety of feedstocks such as brine and aqueous HCl, and to various electrolysis products such as chlorine, caustic soda and hydrogen. There is an implication however that the moulded composite is not resistant to electrolytic oxygen, as an alternative form of the current collector-separator for a water electrolyser is stated to have the anodic side covered by a thin layer of passivated metallic foil thus protecting the graphite current collector against attack by oxygen. This might not be a concern for fuel cells, in which the graphite is not exposed to the same oxidative potentials. A subsequent GE patent, U.S. Pat. No. 4,339,322 entitled “Carbon fiber reinforced fluorocarbon-graphite bipolar current collector-separator”, discloses an improvement to the previous patent achieved by incorporating carbon fibres into the structure so as to increase the flexural strength of the finished separator. Fluoropolymers offer superior corrosion and chemical resistance, but they tend to be expensive. The degree of chemical resistance demanded for electrolysers is, however, higher than that needed in fuel cells as the electrodes are not operated at such chemically active potentials.

Recent reports in the scientific literature have indicated that the development of low cost mouldable bipolar plates specifically for PEM fuel cells has been receiving attention. A group at the University of Duisberg recently reported (K. Ledjeff-Hey et al, “Electronically conducting composite materials as bipolar plates for PEM fuel cells”, 1988 Fuel Cell Seminar, Abstracts pp 570-573, November 16-19, Palm Springs Convention Center, California) on their development of carbon black filled polypropylene composites with a volume resistivity of 0.4 ohm-cm that could be injection moulded into PEM fuel cell bipolar plates. They estimate that optimizing the process conditions should allow volume resistivities of 0.1 ohm-cm to be obtained. Another group at Los Alamos National Laboratory reported at the same seminar (D. N. Busick et al. pp. 632-635) on their work on compression moulding vinyl ester-graphite composites. They claim low material costs, low cycle times (less than 10 minutes!), high flexural strengths and resistivities as low as 0.008 ohm-cm. Long-term corrosion resistance has not been determined for these materials. Yet another group at the same seminar (C. E. Reid et al pp 603-606) reports on its work to optimize metallic bipolar plates. It is pointed out that even stainless steel has a bulk resistivity that is at least an order of magnitude lower than graphite, thus simplifying at least the issue of minimizing the voltage drop across the bipolar plate. The use of metallic plates, however, is complicated by the fact that their corrosion resistance is due to an oxide film, which can impede electron transfer, particularly when the metal comes into direct contact with the electrolyte film.

The possibility of using bipolar plates made out of aluminum has also been the subject of experiment. A patent issued to General Motors Corp., U.S. Pat. No. 5,624,769 entitled “Corrosion resistant PEM fuel cell”, describes a PEM fuel cell having electrical contact elements (including bipolar plates/septums) comprising a titanium nitride coated light weight metal core, having a passivating, protective metal layer intermediate the core and the titanium nitride. The combination of the protective layer and the titanium nitride is designed to overcome the fact that the titanium nitride is difficult to form pinhole free. The protective layer protects the core material in the areas where the pinholes would otherwise allow corrosion to occur. This patent mentions the use of electroless nickel as the protective layer.

### SUMMARY OF THE INVENTION

The use of a highly electrically and thermally conductive material for the bipolar plate is considered to be essential if all of the bipolar plates in a fuel cell stack are to operate in quasi-equipotential and quasi-isothermal conditions over their full areas. It is not sufficient for the average resistance across the plate to be acceptable, as the average can be made up of localized areas supporting a very much higher current density than others and operating at a lower potential. This is due to voltage drops that can occur due to currents flowing in the bipolar plate from one area to another. This potential combination of high current and higher voltage drop can lead to localized heating. Localized heating will lead to locally higher temperatures giving rise to even higher local currents, consequently aggravating the effect, leading to dry out of the membrane and possible local failure. The effect can be compensated by improved thermal and electrical conductivity in the plane of the plate, i.e. perpendicular to the direction of the required current flow. This parameter does not appear to have received much attention in the quest for a low cost, thin bipolar plate having adequate conductivity in the direction across it, i.e. from the anode to the cathode side. Even with pure graphite bipolar plates, the electrical and thermal conductivities are probably insufficient to prevent this effect when very thin plates are required. It has been found that the use of a metal with high electrical and thermal conductivity, such as aluminum, with an electrical conductivity some 500 times higher and a thermal conductivity double that of graphite, can contribute to greatly reducing this effect.

Based on the above, it would be desirable to have bipolar plates consisting of a core layer of aluminum, or similarly highly conductive metal such as copper or titanium, clad with and bonded to moulded, conductive plastic layers, that are inert to the environment of the cell, and which define the required flow fields. There is, however, an intrinsic problem with this type of design, that of maintaining an adequate bond between the aluminum or other metal and the conductive polymer. The bipolar plates that are the subject of this invention, however, overcome this problem by means of mechanical surface treatments applied to the metal core layer. These surface treatments, which can consist of processes as described in U.S. Pat. No. 5,376,410, accommodate the need to maintain an extended consistent and physically secure and conductive contact between the aluminum and the conductive polymer that covers it. For this bipolar plate design, the conductivity of the graphite/plastic layer does not have to be high, as long as the plastic layer is thin enough and sufficiently conductive to allow acceptable voltage drops at the average current density of the plate. Conductivity in the plane of the plate is provided by the aluminum core.

According to the invention, there is provided a bipolar separator plate for electrochemical cells, comprising a core layer of a metal having high electrical and thermal conductivity and having oppositely facing surfaces and cladding layers mechanically binded to each of the oppositely-facing surfaces, each cladding layer comprising an electrically-conductive polymer resistant to the electrochemical conditions to which it will be exposed and effective to protect the core layer from such conditions.

The invention is described further with reference to the accompanying drawings, in which:

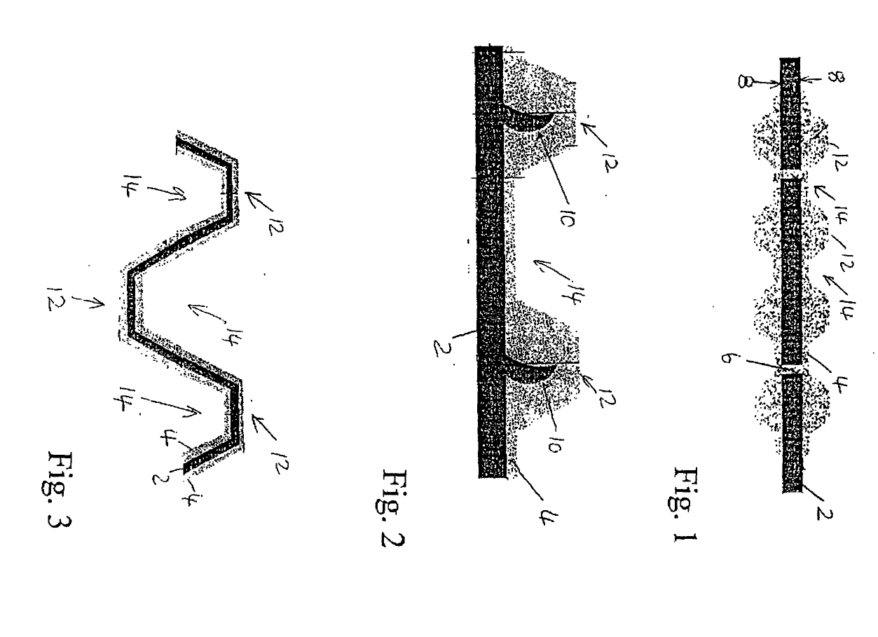

FIG. 1 is a fragmentary cross-section through a bipolar separator plate in accordance with a first embodiment of the invention;

FIG. 2 is a fragmentary cross-section through a bipolar separator plate in accordance with a second embodiment of the invention; and

FIG. 3 is a fragmentary cross-section through a bipolar separator plate in accordance with a third embodiment of the invention.

### DESCRIPTION OF THE PREFERRED EMBODIMENTS

Exemplary embodiments of the invention will now be described with reference to the drawings, which are not drawn to scale, and only show fragments of the plates.

It is to be understood that the drawings are for illustrative purposes only and that such plates can intrinsically be of any practical size and that the channels defining the flow-fields for the reactant gases can nominally be of any number or geometry. FIG. 1 shows an aluminum core 2, typically from 0.1 to 2 mm in thickness, that is completely covered on both sides by a suitable conductive polymer layer 4. Examples of polymers suitable for this conductive polymeric layer are polypropylene containing from 30 to 80 wt % carbon, but any suitably conductive polymeric material that is resistant to the environmental conditions present in the operating fuel cell is also suitable. Each of the polymeric layers may be formed on its outer surfaces with ridges 12 and channels 14 defining a flow field. The conductive polymeric layer is locked to the aluminum sheet by means of a mechanical surface treatment that is applied to the opposite surfaces 8 of the aluminum prior to application of the polymeric layer. This surface treatment is typically that described in U.S. Pat. No. 5,371,410. This surface treatment can be the sole means of assuring the bond between the aluminum and the polymer, but it can also be used in conjunction with perforations 6 made through the aluminum core prior to application of the surface treatment or the polymeric layer. It is understood that the surface perforations might also be used to assure contact between the polymeric layer and the aluminum without application of the surface treatment process, or that treatment process such as metal expansion or punchings through the metal may be used that combine surface deformation and perforation. The aluminum surface, either before or after perforation or mechanical treatment of its surface can also be chemically treated or modified so as to improve its long term durability and conductivity in the environment in the cell. Such treatments can be any of a number known to improve the surface conductivity of aluminum and overcome problems resulting from its characteristic surface passivation, including such processes as electroless deposition of nickel (or nickel-phosphorus) or surface zincating followed by nickel electroplating.

FIG. 2 shows a second embodiment of the invention and represents one side only of a bipolar plate structure. As the conductivity of graphite or carbon filled polymers, which retain their ability to be easily moulded and to have low permeability, tends to be in the range of 1 to 100 Siemens/cm, thick polymeric layers compromise the performance of fuel cells containing such materials in the path of the electric current generated by the cell. FIG. 2 shows how the surface treatment of the aluminum core 2 can be arranged so as to minimize the resistance of the bipolar plate. In this case, integral burrs 10 ploughed out of the surface of the aluminum are located in accordance with the surface profile of the plate, so as to approach the surface of the polymer layer 2 in areas 12 where the current is being collected, and so as to minimize the electrical path length through the conductive polymer. The effect that such burrs 10 can have on the resistance across such a plate is illustrated in Table 1, where the results for a structure in accordance with FIG. 1 are compared with those for a structure in accordance with FIG. 2 but with the same surface configuration, and also with figures for a structure in accordance with FIG. 3.

FIG. 3 represents another embodiment of the invention. In this case the polymeric layer is thinner and the channels in the bipolar plate are formed by the deformation of the whole structure. As can be seen in Table 1, the resistance of such structures is very attractive and the use of materials is minimized. One method of realizing this structure is to make up a laminated sheet consisting of the aluminum and polymeric layer, suitably bonded together, and then to form the required bipolar plate structure directly from the laminate. This forming process can be by means of several well known techniques, such as pressing or stamping. In this case the polymeric layer does not have to be moulded, as coating processes such as those used to lay down conductive inks can be applied. Subsequent requirements to either bond or form the layers can be applied before or after the forming process.

A further advantage of the use of an aluminum (or other highly thermal and electrical metallic) core for bipolar plates is that it allows for sealing gaskets to be easily co-moulded on to the plate structure, thus simplifying assembly and reducing the costs of the final cell.

TABLE 1

| | Voltage drop across plate at 1 Å/cm², | | |
|---|---|---|---|
| Polymer | structure as per | | |
| Conductivity (S/cm) | | | Figure 3 |
| 2.5 | 0.156 | 0.0675 | 0.018 |
| 5.0 | 0.078 | 0.0338 | 0.009 |
| 10.0 | 0.039 | 0.0169 | 0.005 |
| 20.0 | 0.0195 | 0.0084 | 0.002 |

1. A bipolar separator plate for electrochemical cells, comprising a core layer of a metal having high electrical and thermal conductivity and having oppositely facing surfaces and cladding layers mechanically bonded to each of the oppositely facing surfaces, each cladding layer comprising an electrically-conductive polymer resistant to the electrochemical and environmental conditions to which it will be exposed in the cell and effective to protect the core layer from such conditions.

2. A bipolar separator plate according to claim 1, wherein the core layer is covered on at least one of its oppositely facing surfaces with a layer of metallic or non-metallic conductive material, between the core conductive layer and the conductive polymer of the cladding layer, said metallic or conductive material being resistant to the electrochemical and environmental conditions in the cell and maintaining continuity of electrical contact between the core layer metal and the conductive polymer of the cladding layer applied to that surface.

3. A bipolar separator plate according to claim 1 or 2, wherein external surfaces of the cladding layers are configured with ridges and channels defining flow fields therein.

4. A bipolar separator plate according to claim 3, wherein at least one of the oppositely-facing surfaces of the core layer is formed with ridges or protuberances extending into the ridges of the cladding layers.

5. A bipolar separator plate according to claim 4, wherein the protuberances are formed by a process which locally ploughs non-detached tongues of metal out of the surface of the core layer.

6. A bipolar separator plate according to claim 3, wherein the core and cladding layers are conjointly pressed to form said ridges and channels, with ridges on one external surface opposite channels in an opposite external surface.

7. A bipolar separator plate according to any one of claims 1 to 6, wherein the core layer is perforated, and the cladding layers are joined through the perforations.

8. A bipolar separator plate according to any one of claims 1 to 6, wherein the core layer is of aluminum.

9. A bipolar separator plate according to claim 8, wherein the opposite surfaces of the aluminum are chemically treated to improve at least one of their conductivity and resistance to corrosion.

10. A bipolar separator plate according to claim 9, wherein the surfaces are treated by one of electroless deposition of nickel, surface zincating followed by electroless deposition of nickel, and surface zincating followed by nickel electroplating.

11. A bipolar separator plate according to claim 9, wherein the surfaces are treated by any of the electroless or electrolytic process that are known to improve the resistance of aluminum to surface oxidation or corrosion.

12. A bipolar separator plate substantially as hereinbefore described with reference to FIGS. 1, 2 or 3 of the accompanying drawings.
